(19) United States
(12) Patent Application Publication
(10) Pub. No.: US 2024/0413767 A1
(43) Pub. Date: Dec. 12, 2024

(54) SYSTEMS AND METHODS FOR MODULATION INDEX CONTROL OF A DC-TO-AC INVERTER

(71) Applicant: DRS Network & Imaging Systems, LLC, Melbourne, FL (US)

(72) Inventor: James C. Vandiver, Huntsville, AL (US)

(73) Assignee: DRS Network & Imaging Systems, LLC, Melbourne, FL (US)

(21) Appl. No.: 18/738,933

(22) Filed: Jun. 10, 2024

Related U.S. Application Data
(60) Provisional application No. 63/507,604, filed on Jun. 12, 2023.

(51) Int. Cl. H02M 7/5387

(52) U.S. Cl. CPC H02M 7/53873

(57) ABSTRACT

Techniques are disclosed for recursively determining a modulation index for controlling a DC-to-AC inverter. A modulation index can be selected initially. The input voltage to the power inverter can be measured. Based on the input voltage and the selected modulation index, an output voltage of the power inverter may be estimated. The output current of the power inverter can be measured. Using the estimated output voltage and the measured output current, a real power and a reactive power can be determined. The real power and the reactive power can be used to determine an updated modulation index. The updated modulation index factor can be used to generate pulse width modulation signals that are used to control the power inverter.

### CROSS-REFERENCE TO RELATED APPLICATION

This application claims priority to U.S. Provisional Patent Application No. 63/507,604, filed on Jun. 12, 2023, and entitled “SYSTEMS AND METHODS FOR MODULATION INDEX CONTROL OF A DC-TO-AC INVERTER,” the entire contents of which are herein incorporated by reference in their entirety for all purposes.

### BACKGROUND OF THE INVENTION

Vehicular power systems can be used to supply both DC and AC power to various loads. The equipment used for power generation and line conditioning may occupy limited space within the vehicle. Moreover, the characteristics of the various loads may be important to the operation of the vehicular power systems but can vary significantly, thus complicating the design and implementation of the power systems.

Therefore, there is a need in the art for improved methods and systems related to power generation systems.

### SUMMARY OF THE INVENTION

Embodiments of the present invention relate to power generation systems. More particularly, embodiments of the present invention provide methods and systems that control the output of a power inverter through modulation index control. Merely by way of example, embodiments of the present invention have been applied to machine controllers, but the present invention has wider applicability in electrical power systems.

According to an embodiment of the present invention, a method for controlling a power inverter is provided. The method may be performed, for example, by control components of the power inverter or a control system connected to the power inverter. The method includes selecting a modulation index, measuring an input voltage to the power inverter, and estimating an output voltage of the power inverter based on the input voltage and the modulation index. The method also includes measuring the output current of the power inverter. Using the output current and the output voltage, the method can determine a real power and a reactive power. The method also includes determining an updated modulation index using the real power and the reactive power, generating pulse width modulation signals using the updated modulation index, and controlling the power inverter using the pulse width modulation signals.

In some embodiments, updating the modulation index can further include computing an estimated output voltage of the power inverter using the modulation index and the measured input voltage.

In some embodiments, determining the real power and the reactive power can include applying a direct-quadrature-zero transform to the output current to produce a direct current component and a quadrature current component, and computing the real power and the reactive power using the direct current component, the quadrature current component, and the estimated output voltage.

In some embodiments, the method can further include generating updated pulse width modulation signals using the updated modulation index, the updated pulse width modulation signals causing the power inverter to produce an updated output current.

In some embodiments, updating the modulation index can be performed iteratively at a predefined rate.

In some embodiments, measuring the input voltage can include measuring the input voltage at the predefined rate, and measuring the output current can include measuring the output current at the predefined rate.

In some embodiments, the predefined rate is about 19.2 kHz.

In some embodiments, determining the updated modulation index can further include applying a gain factor to the selected modulation index, the determined real power, and the determined reactive power.

In some embodiments, controlling the power inverter can include using the pulse width modulation signals to control switching elements of the power inverter to produce an output current from the power inverter.

According to another embodiment of the present invention, a method for controlling a power inverter is provided. The method may be performed, for example, by control components of the power inverter or a control system connected to the power inverter. The method includes (a) measuring an input voltage to the power inverter and (b) computing a nominal output voltage based on a modulation index. The method also includes (c) measuring an output current of the power inverter, (d) determining a real power and a reactive power using the nominal output voltage and the output current, and (e) determining an updated modulation index using the real power and the reactive power. The method also includes iteratively performing steps (a) through (e).

In some embodiments, determining the real power and the reactive power can include applying a direct-quadrature-zero transform to the output current to produce a direct current component and a quadrature current component; computing the real power according to

$${P}_{avg} = \frac{3}{2} ( {V}_{D} {I}_{D} + {V}_{Q} {I}_{Q} ) ,$$

wherein P_{avg} is the real power, V_{D} is a direct voltage component, V_{Q} is a quadrature voltage component, I_{D} is the direct current component, and I_{Q} is the quadrature current component; and computing the reactive power according to

$${Q}_{avg} = \frac{3}{2} ( {V}_{D} {I}_{Q} + {V}_{Q} {I}_{D} ) ,$$

wherein Q_{avg} is the reactive power.

In some embodiments, the direct voltage component V_{D}=0, the quadrature voltage component

$${V}_{Q} = \frac{{V}_{AC}}{\sqrt{3}} ,$$

and V_{AC} can be the nominal output voltage.

In some embodiments, the method can further include measuring a load voltage at a load electrically connected to the power inverter.

In some embodiments, determining the updated modulation index can include applying, using a proportional-integral controller, an integral correction to the load voltage to produce a corrected load voltage; computing a first index factor using the real power and the reactive power; computing a second index factor using the corrected load voltage; and computing a weighted sum of the first index factor and the second index factor to produce the updated modulation index.

In some embodiments, generating the output current can include generating pulse width modulation signals using the updated modulation index, the pulse width modulation signals usable to control switching elements of the power inverter to produce the output current from the power inverter.

In some embodiments, iteratively performing steps (a) through (e) can occur at a predefined rate.

According to a specific embodiment of the present invention, a power inverter system is disclosed. The power inverter system includes a line interface filter and a generator controller bus regulator electrically connected to the line interface filter. The line interface filter may include filter components that have predetermined component values. The generator controller bus regulator may be configured to receive DC power and generate AC power by iteratively updating a modulation index. The modulation index may be characterized by the predetermined component values.

In some embodiments, the generator controller bus regulator can be configured to iteratively update the modulation index by measuring an input voltage of the DC power; measuring an output current from the generator controller bus regulator to the line interface filter; determining a real power and a reactive power using the input voltage and the output current; and determining the modulation index using the determined real power, the determined reactive power, and a load-independent modulation index.

In some embodiments, the power inverter system can further include an isolation transformer electrically connected to the line interface filter.

In some embodiments, the isolation transformer can be characterized by a turns ratio and a winding number, and wherein the line interface filter and the isolation transformer can be configured to receive the AC power generated by the generator controller bus regulator and transmit a corresponding AC output to a load connected to the isolation transformer.

According to another specific embodiment of the present invention, a system is provided. The system includes a vehicle engine, a generator connected to the vehicle engine, a generator controller bus regulator electrically connected to the generator, and a power inverter electrically connected to the generator controller bus regulator. The generator may be operable to generate an electric current. The power inverter may be operable to rectify the electric current to produce DC input power. The power inverter may be operable to receive the DC input power and generate output AC power by iteratively updating a modulation index.

In some embodiments, the generator controller bus regulator can be a first generator controller bus regulator, and the power inverter can include a second generator controller bus regulator and a line interface filter. The second generator controller bus regulator can be configured to measure an input voltage of the DC input power into the second generator controller bus regulator; measure an output current from the second generator controller bus regulator; determine a real power and a reactive power using the input voltage and the output current; and iteratively update the modulation index using the determined real power and the determined reactive power.

In some embodiments, the line interface filter can include filter components having predetermined component values. Determining the real power and the reactive power can include computing the real power and the reactive power using the input voltage, the output current, and the predetermined component values.

In some embodiments, the system can include a sensor electrically connected to an output of the power inverter and configured to measure an output voltage from the power inverter to a load electrically connected to the power inverter.

In some embodiments, the output voltage can be three-phase, and the sensor can be configured to measure a voltage for each phase of the output voltage.

Numerous benefits are achieved by way of the present invention over conventional techniques. For example, embodiments of the present invention provide methods and systems that utilize measurements of input current/voltage to approximate output current/voltage and control the modulation index of a power inverter to achieve a substantially constant output voltage independent of changes in the load. These, and other embodiments of the invention, along with many of its advantages and features, are described in more detail in conjunction with the text below and attached figures.

### BRIEF DESCRIPTION OF THE DRAWINGS

FIG. 1 is a block diagram of an example method for recursively updating a modulation index for use generating output AC power, according to an embodiment.

FIG. 2 is a block diagram of a power inverter configured to recursively update a modulation index, according to some embodiments.

FIG. 3 is a block diagram of another example method for updating a modulation index, according to an embodiment.

FIG. 4 is a block diagram of example steps for determining a real power and reactive power output from a power inverter, according to some embodiments.

FIG. 5 is a block diagram of a system for generating AC power from rectified DC power using recursive modulation index control, according to some embodiments.

FIG. 6 is a plot illustrating the linearity of modulation index values versus apparent power for various power factors of a load, according to some embodiments.

FIG. 7 is a circuit diagram of an example line interface filter of a power inverter, according to some embodiments.

FIG. 8 is a block diagram of a control circuit for computing a modulation index using measured output current and measured load voltage, according to some embodiments.

FIG. 9 is a block diagram of a circuit for generating pulse width modulation signals to control switching elements of a power inverter, according to some embodiments.

FIG. 10 is a block diagram of a proportional-integral (PI) controller for determining an average modulation index, according to an embodiment.

FIGS. 11A-11C are plots illustrating the response of an example power inverter when an inductive load is connected, according to some embodiments.

FIG. 11A illustrates an AC output voltage from the power inverter when the inductive load is connected and subsequently disconnected.

FIG. 11B illustrates the power factor, modulation index, and sine of the phase angle of the power inverter when the inductive load is connected and subsequently disconnected.

FIG. 11C illustrates the apparent power, real power, and reactive power from the power inverter when the inductive load is connected and subsequently disconnected.

FIGS. 12A-12C are plots illustrating the response of an example power inverter when a capacitive load is connected, according to some embodiments.

FIG. 12A illustrates an AC output voltage from the power inverter when the capacitive load is connected and subsequently disconnected.

FIG. 12B illustrates the power factor, modulation index, and sine of the phase angle of the power inverter when the capacitive load is connected and subsequently disconnected.

FIG. 12C illustrates the apparent power, real power, and reactive power from the power inverter when the capacitive load is connected and subsequently disconnected.

Like reference symbols in the various drawings indicate like elements, in accordance with certain example implementations. In addition, multiple instances of an element may be indicated by following a first number for the element with a letter or a hyphen and a second number.

### DETAILED DESCRIPTION OF SPECIFIC EMBODIMENTS

The present disclosure relates to methods and systems that provide DC-to-AC power inversion using a machine controller by recursively updating a modulation index used to control the machine controller. In particular, a vehicular power generation system can include a first machine controller that provides rectification and conditioning of AC power produced by a motor or generator. A machine controller can include an active three-phase bridge, a DC link capacitor, sensors for input and output currents and voltages, and control electronics. The output of the first machine controller can be a DC voltage output on a DC voltage bus that can provide power for various loads, for example batteries, electronic devices, and the like. To provide power for other loads that use an AC input, for instance motors, the DC voltage from the first machine controller can be inverted using a second machine controller to produce an AC output.

Using a second machine controller allows for a system design that is simplified and economical, with duplicate machine controllers providing both the AC-to-DC stage and the DC-to-AC stage, without a dedicated AC-to-DC inverter. However, the second machine controller may not have a mechanism to sense the voltage and current at the load, limiting its ability to control the generated AC output waveform when the characteristics of the load change. A typical DC-to-AC inverter includes control electronics to generate switching waveforms, an active bridge, a low-pass filter to suppress switching artifacts on the output, and sensing elements for its input and output to the load. The machine controller, by contrast, does not include the filter at its output, since the loads driven by the machine controller (e.g., motors or generators) include inductances that inherently provide for filtering of high-frequency artifacts. A line filter can then be included in the vehicular power system at the output of the second machine controller. The second machine controller can sense its output current and voltage supplied to the line filter, but may not have the ability to sense the voltage and current at a load.

To compensate for not sensing the voltage and current at the load, the second machine controller can be configured to regulate the output current at the load using the local measurements of the current output from the second machine controller. More specifically, the second machine controller can be configured to iteratively adjust a modulation index based on the apparent power delivered by the second machine controller. The modulation index is a dimensionless parameter that modifies the amplitude of the sinusoidal input signals used to generate the pulse width modulation control signals within the machine controller. Aspects of the present disclosure reveal that the modulation index varies approximately linearly with respect to the apparent power produced by the machine controller acting as an DC-to-AC inverter. This linearity allows for a recursive definition of the modulation index that is both stable and independent of the load characteristics (e.g., the load impedance), which allows for the machine controller to be configured to regulate the AC output quickly with respect to changing load conditions and without direct sensing of the voltage and current delivered to the load.

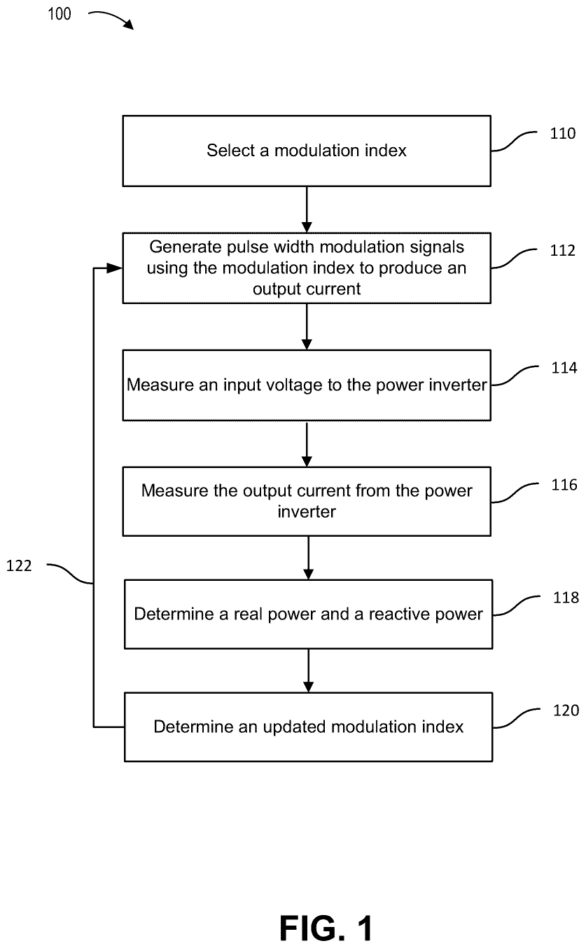

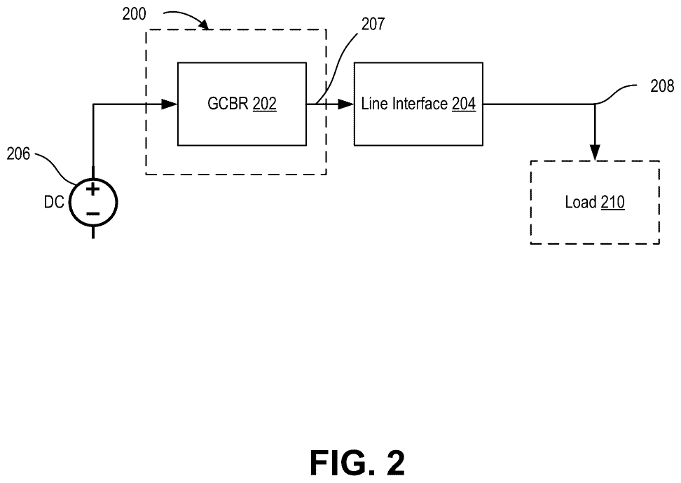

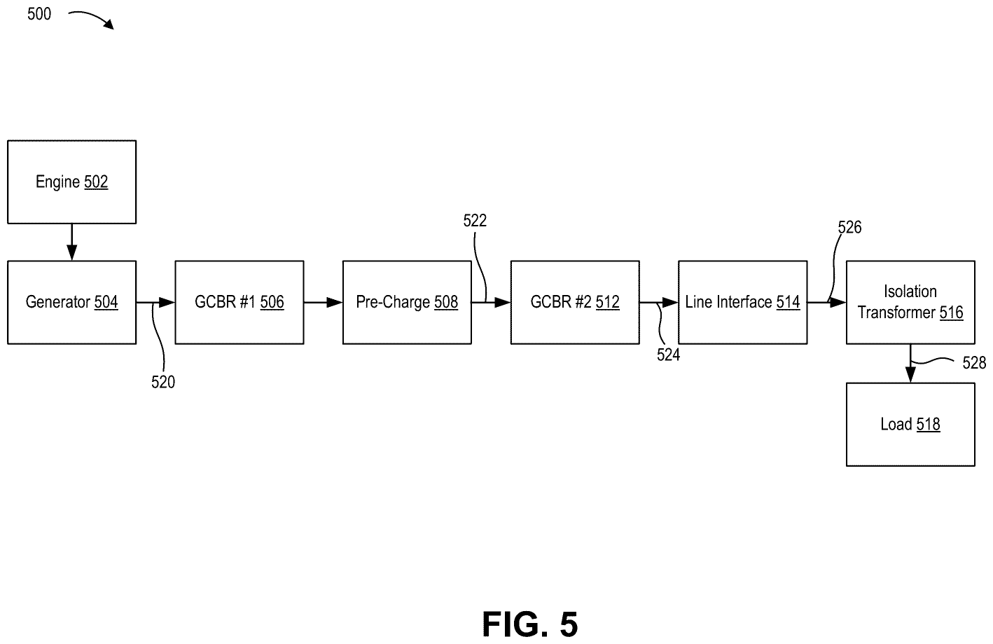

FIG. 1 is a block diagram of an example method 100 for recursively updating a modulation index for use generating output AC power, according to an embodiment. In some examples, one or more of the operations described for method 100 may be performed by a generator controller bus regulator (GCBR), an example of a machine controller discussed briefly above and described in detail below with respect to FIGS. 2 and 5. Additionally or alternatively, one or more of the operations of method 100 may be performed by one or more components of a power inverter system 500 described below with respect to FIG. 5.

The method can include selecting a modulation index (110). The selected modulation index value can be an initial value for the modulation index for a recursive computation of an updated modulation index. For a three-phase voltage source DC-to-AC inverter, the modulation index m determines the amplitude of the output voltage waveform by Vₚₖ=mV_{DC}, where V_{DC} is the DC voltage at the input of the inverter (e.g., the DC bus voltage at the input of the second machine controller). For a single phase, the amplitude of the voltage is reduced by a factor of \sqrt{3}, giving a relationship between the modulation index, the desired output voltage V_{AC}, and the input DC voltage as

$$m = \sqrt{3} \frac{{V}_{AC}}{{V}_{DC}} .$$

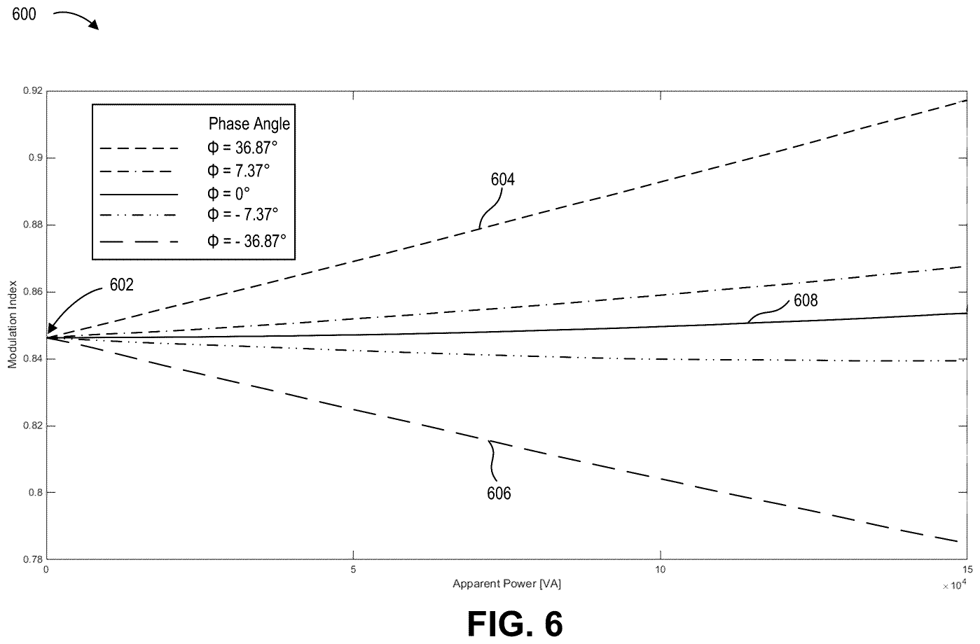

Because the characteristics of the load may change the value the current delivered to the load, maintaining a fixed value of V_{AC} can require updates to the modulation index. As described below with respect to FIG. 6, the value of the modulation index required to maintain a fixed V_{AC} is linearly related to the apparent power entering the load. The apparent power entering the load depends on the output voltage V_{AC} and the output current from the GCBR. The linear relationship between the modulation index and the apparent power at the load indicates a value for the load-independent modulation index, which is a value of the modulation index when no load is connected (an intercept of the linear relationship). The load-independent modulation index m₀ (i.e., the no-load modulation index) can depend on the characteristics of the filter components (e.g., impedance values of inductive, capacitive, and resistive elements). In some embodiments, selecting the modulation index at operation (110) can include selecting the value of the load-independent modulation index m₀.

Turning to FIG. 2, a power inverter 200 can be configured to recursively update a modulation index according to method 100. The power inverter can include a GCBR 202. The output 207 of the power inverter 200 can be connected to a line interface 204. The line interface 204 can be a low-pass filter for the AC output of GCBR 202 to suppress high-frequency switching artifacts from the GCBR 202. The line interface 204 can include inductive elements such as line reactors, common-mode chokes, and an isolation transformer, as well as an RC filter network to provide suitable filtering characteristics for the output voltage and current signals. The input to power inverter 200 can be a DC input 206, which can be provided, in several examples, by a first machine controller providing AC-to-DC power conversion from a motor or generator driven by a vehicle's engine. As a particular example for vehicular power systems, the DC input 206 may have a nominal value of 600 V_{DC}.

The AC output 208 from the line interface 204 can be a three-phase voltage/current. The AC output 208 can provide power to a load 210. The load 210 may be a variety of systems that rely on AC power, including motors, high-power electronic devices, and the like. As a particular example for vehicular power systems, the AC output 208 may have a nominal value of 208 V_{AC} (line to line) in a wye configuration (120 V_{AC} line to neutral). In some examples, the AC output 208 from the line interface 204 may also be determined by the turns ratio and the winding configuration of the isolation transformer.

The GCBR 202 can include sensing elements to measure voltages and currents both at its input (e.g., DC input 206) and at its output (e.g., output 207). As discussed briefly above, the output voltage of the GCBR 202 may include high frequency switching artifacts, which can cause a measured value of the output voltage to differ substantially from a nominal voltage value for the expected AC waveform.

Returning to FIG. 1, the method 100 can also include generating pulse width modulation signals using the modulation index to produce an output current. The PWM signals may be used to control switching elements in the GCBR. For example, the PWM signals may be used to control insulated gate bipolar transistors (IGBTs) used to provide the output AC waveforms. The PWM signals may be generated by, for example, space vector modulation using three-phase sinusoidal input signals. Each of the sinusoidal input signals may be multiplied by the modulation index and used to produce the output PWM signals.

The method 100 can also include measuring an input voltage (114). The input voltage can be an input voltage to a power inverter (e.g., DC input 206 to power inverter 200). The output current from the power inverter can also be measured (116). With reference to FIG. 2, the GCBR 202 can measure its input voltage (DC input 206) and its output current (output 207).

Using the measured input voltage and output current, a real power and a reactive power can be determined (118). The real power and the reactive power are components of the apparent power provided by the inverter. The apparent power can depend on the output current and output voltage from the power inverter. Because the output voltage can contain artifacts that render any measurement unsuitable for computations, the measured input voltage V_{DC} can be used as a proxy according to the relationship

$${V}_{AC} = m \frac{{V}_{DC}}{\sqrt{3}}$$

described above. The real power and the reactive power can be determined using a direct-quadrature-zero transformation (e.g., successive applications of a Clarke and a Park transformation) on the measured output current.

The real power and reactive power values determined in (118) can then be used to determine an updated modulation index (120). The linear relationship between the modulation index and the apparent power can be expressed as m=γ[m₀+μₚP_{avg}+μ_{q}Q_{avg}], where P_{avg} is the real power, Q_{avg} is the reactive power, m₀, μₚ and μ_{q} are coefficients that depend on the characteristics of the load and the filter, and γ is a gain factor. The coefficients m₀, μₚ and μ_{q} may be determined empirically for a given configuration of filter components. The gain factor γ can be a correction for any deviation between the measured input voltage (V_{DC}) and the nominal DC voltage input into the power inverter (Vₙₒₘ),

$$γ = \frac{{V}_{nom}}{{V}_{DC}} .$$

For example, for a vehicular power system that has a 600 V nominal DC stage output, if the GCBR measures its input voltage to be 598 V, then the gain factor for determining an updated modulation index will be 1.003.

After determining the updated modulation index, the previous operations can be iteratively repeated using the updated modulation index (122). The updated modulation index can be used to modify the PWM signals used to generate the output current, producing a new output current. The new output current can result in a corresponding change to the apparent power delivered to the load. The input voltage and output current can be measured again and used to again update the modulation factor. The iterative process can occur at a predefined rate. For example, the GCBR can be configured to measure its input and output signals at 19.2 kHz to update the modulation index.

Although FIG. 1 shows example blocks of method 100, in some implementations, method 100 may include additional blocks, fewer blocks, different blocks, or differently arranged blocks than those depicted in FIG. 1. Additionally, or alternatively, two or more of the blocks of method 100 may be performed in parallel. Other sequences of steps can also be performed according to alternative embodiments. For example, alternative embodiments of the present disclosure can perform the steps outlined above in a different order. Moreover, the individual steps illustrated in FIG. 1 can include multiple sub-steps that can be performed in various sequences as appropriate to the individual step. Furthermore, additional steps can be added or removed depending on the particular applications. One of ordinary skill in the art would recognize many variations, modifications, and alternatives.

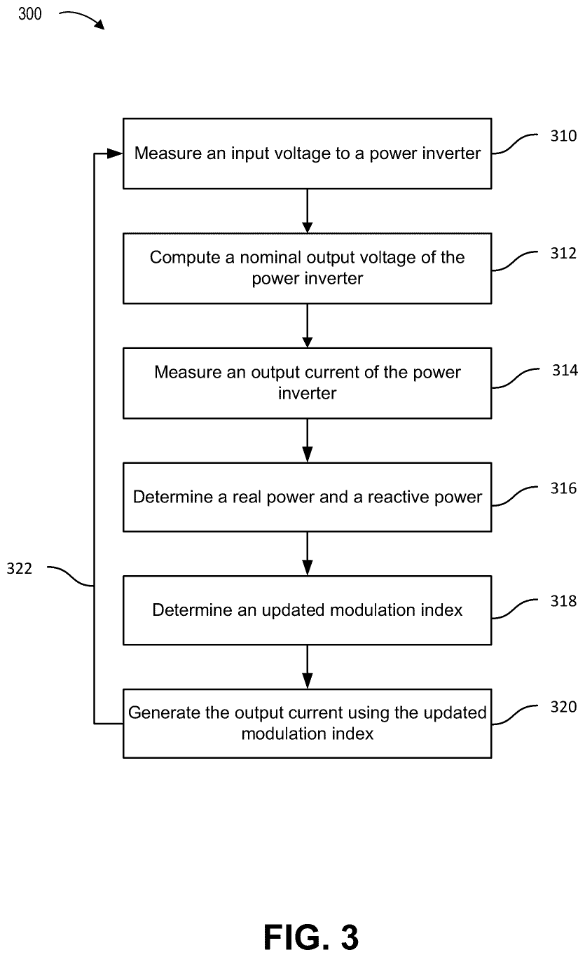

FIG. 3 is a block diagram of another example method 300 for updating a modulation index, according to an embodiment. One or more of the operations of method 300 may be performed by a power inverter, including GCBR 202 of FIG. 2. Method 300 can include measuring an input voltage to the power inverter (310). The input voltage to the power inverter may be the DC voltage. Using the measured input voltage, a nominal output voltage of the power inverter can be computed (312). Computing the nominal output voltage can include multiplying the measured input voltage by a modulation index. The nominal output voltage may be the amplitude of an AC output voltage waveform. For example, for a measured input voltage V_{DC} and a modulation index m, the nominal output voltage can be V_{AC}=mV_{DC}. The AC output from a power inverter may be a three-phase output, so that the nominal output voltage V_{AC} can be the line-to-line voltage, with a corresponding line-to-neutral voltage computed by reducing V_{AC} by a factor of \sqrt{3}.

The method 300 can also include measuring an output current of the power inverter (314). The output current may be a three-phase AC output. Measuring the output current can include measuring the instantaneous current for all three-phases of the AC output. For example, the output current can include Iₐ, I_{b}, and I_{c} as the magnitude of the current for the three-phases, so that measuring the output current can include measuring each of Iₐ, I_{b}, and I_{c}.

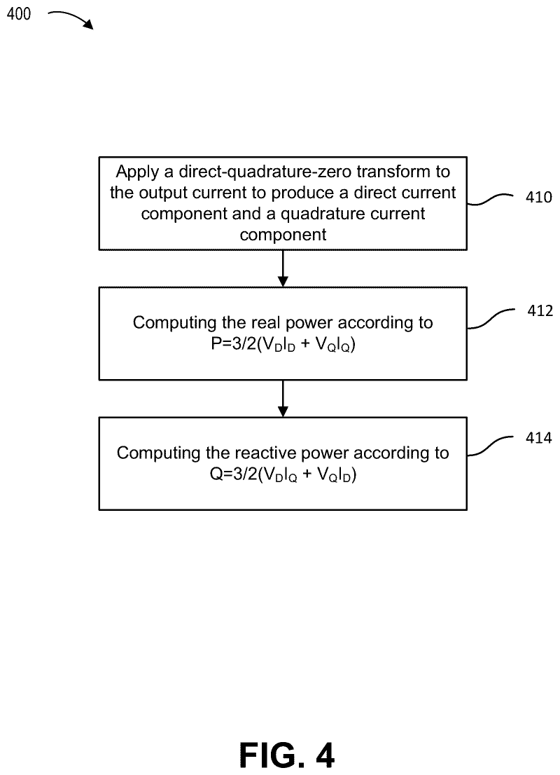

With the measured output current and the computed output voltage, a real power and a reactive power output from the power inverter can be determined (316). The real power and the reactive power can be determined using a direct-quadrature-zero transformation on the measured output current components Iₐ, I_{b}, and I_{c}. Additional detail about the application of the direct-quadrature-zero transformation is provided below with respect to FIG. 4.

The method 300 can also include determining an updated modulation index using the real power and the reactive power (318). The updated modulation index may be given as m=γ[m₀+μₚP_{avg}+μ_{q}Q_{avg}], where P_{avg} is the real power, Q_{avg} is the reactive power, μₚ and μ_{q} are coefficients that depend on the characteristics of the load and the filter, and γ is a gain factor. The updated modulation index can be used by the power inverter to generate the output current from the power inverter (320). As described above with respect to FIG. 1, the power inverter can use the modulation index as a multiplicative factor to scale the control waveforms for the pulse width modulation signals that are used to generate the output current.

With an updated modulation index, the output current may change. The method 300 can iteratively update the modulation index by measuring the input voltage and output current again and determining further updates to the modulation index (322). The iterative process can occur at a predetermined rate. In addition, if the characteristics of a load that receives power from the power inverter change, then the iterative updating of the modulation index can allow the power inverter to respond quickly to the changes to maintain nominal output current values.

The method 300 may include additional implementations, such as any single implementation or any combination of implementations described below and/or in connection with one or more other processes described elsewhere herein.

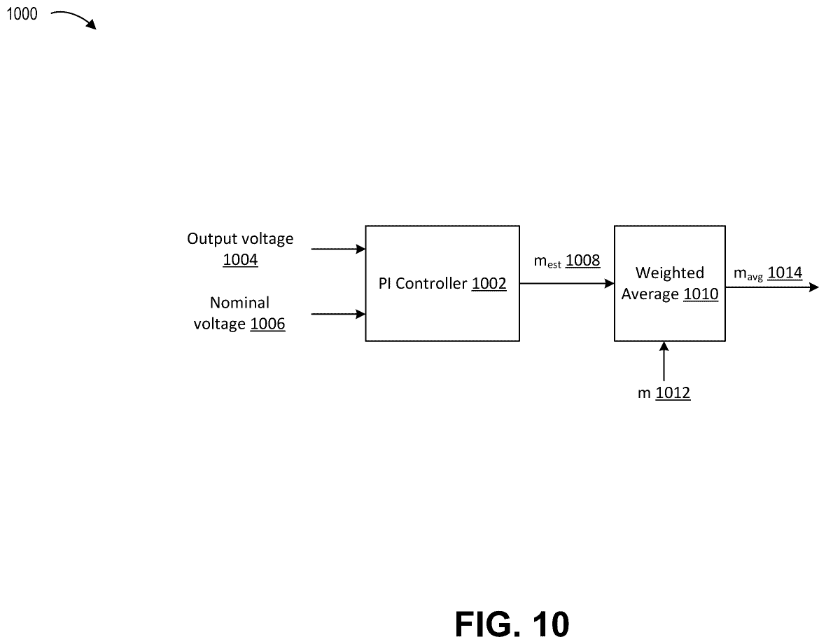

In one implementation, the power inverter may be configured to obtain a measurement of the load voltage. The method 300 can then include measuring a load voltage at a load electrically connected to the power inverter. Determining the updated modulation index can then include applying an integral correction to the load voltage to produce a corrected load voltage, computing a first index factor using the real power and the reactive power, computing a second index factor using the corrected load voltage, and computing a weighted sum of the first index factor and the second index factor to produce the updated modulation index. Additional details of this hybrid computation are discussed below with respect to FIG. 10.

Although FIG. 3 shows example blocks of method 300, in some implementations, method 300 may include additional blocks, fewer blocks, different blocks, or differently arranged blocks than those depicted in FIG. 3. Additionally, or alternatively, two or more of the blocks of method 300 may be performed in parallel. Other sequences of steps can also be performed according to alternative embodiments. For example, alternative embodiments of the present disclosure can perform the steps outlined above in a different order. Moreover, the individual steps illustrated in FIG. 3 can include multiple sub-steps that can be performed in various sequences as appropriate to the individual step. Furthermore, additional steps can be added or removed depending on the particular applications. One of ordinary skill in the art would recognize many variations, modifications, and alternatives.

FIG. 4 is a block diagram of example steps 400 for determining a real power and reactive power output from a power inverter, according to some embodiments. The example steps 400 may be an example of operation 316 of method 300 described above with respect to FIG. 3, and may be performed by any of the power inverters described herein, including the power inverter 200 of FIG. 2.

The steps 400 can include applying a direct-quadrature-zero transformation to the (measured) output current from the power inverter (410). For a three-phase output current from the power inverter, the output current will have a component for each phase. The measured output current can include the instantaneous amplitude of each component, represented as Iₐ, I_{b}, and I_{c}. The measured output current can also include a measured or assumed phase angle between each component. For example, a typical three-phase current signal will have a 120° phase angle between each component. A direct-quadrature-zero transformation can transform the components of the three-phase waveform into a rotating basis in which the transformed components are DC signals, thereby simplifying analysis. The direct-quadrature-zero transform produces three corresponding signal components, the direct “D,” quadrature “Q,” and zero “0” components.

The direct-quadrature-zero transformation is given as

$${K}_{CP} = 2 / 3 [ \begin{matrix}cos θ & cos ( θ - \frac{2 π}{3} ) & cos ( θ + \frac{2 π}{3} ) \\ - sin θ & - sin ( θ - \frac{2 π}{3} ) & - sin ( θ + \frac{2 π}{3} ) \\ \frac{1}{2} & \frac{1}{2} & \frac{1}{2}\end{matrix} ] , \qquad ( 1 )$$

where θ is the phase angle of an arbitrary frequency ω of the transformation basis. Then, the transformed current components I_{DQ0}=[I_{D} I_{Q} I₀] can be obtained from the measured current components I_{abc}=[Iₐ I_{b} I_{c}] by I_{DQ0}=K_{CP} I_{abc}^{T}, where I_{D} is the direct current component, I_{Q} is the quadrature current component, and I₀ is the zero current component. In most cases, the zero current component, which corresponds to an average of the three AC components, should have a value of zero.

The real power can be computed using

$${P}_{avg} = \frac{3}{2} ( {V}_{D} {I}_{D} + {V}_{Q} {I}_{Q} )$$

(412). If a three-phase voltage signal were obtained at a load connected to the power inverter, the direct-quadrature-zero transformation could be applied to the voltage components in the same way as described above for the current components, to produce a direct voltage component V_{D}, a quadrature voltage component V_{Q}, and a zero voltage component V₀. However, since the input DC voltage can be used as a proxy for the magnitude of the output AC voltage, and since the basis for the direct-quadrature-zero transformation is arbitrary, the values of V_{D}, V_{Q}, and V₀ can be set using the computed output voltage V_{AC}. The direct voltage component and zero voltage component can be set to 0, V_{D}=0, V₀=0, while the quadrature voltage component can be set

$${V}_{Q} = \frac{{V}_{AC}}{\sqrt{3}} .$$

The reactive power can be computed using

$${Q}_{avg} = \frac{3}{2} ( {V}_{D} {I}_{Q} + {V}_{Q} {I}_{D} )$$

(414). As with computing the real power, the direct voltage component can be set to 0 while the quadrature voltage component can be set as

$${V}_{Q} = \frac{{V}_{AC}}{\sqrt{3}} .$$

FIG. 5 is a block diagram of a system 500 for generating AC power from rectified DC power using recursive modulation index control, according to some embodiments. The system 500 may be a vehicular power system in which an engine 502 (e.g., a vehicle engine) can be used to drive a generator 504 to produce the input power for AC-to-DC and DC-to-AC power conversion stages. Exemplary vehicles that can implement the power inverter techniques described herein can include medium tactical vehicle (MTV) variants, light MTVs (LMTVs), mine-resistant ambush protected (MRAP) all-terrain vehicles (M-ATVs) and other MRAP vehicle variants, Humvees, Stryker variants, and the like. The generator 504 can be a generator connected to the engine 502, for example integrated into the transmission of the vehicle. The generator 504 can include magnetic rotors that are turned within stator windings by the vehicle transmission to produce three-phase AC electrical power 520. The three-phase AC electrical power can be variable voltage and variable frequency (VVVF) depending on the speed of the engine/transmission driving the rotors of the generator 504.

The three-phase AC electrical power 520 can be routed to a first generator controller bus regulator (GCBR) 506. The first GCBR 506 can convert the AC input power to a DC output power. The first GCBR 506 can include an active three-phase bridge, a DC link capacitor, sensors for input and output currents and voltages, and control electronics for controlling the switching elements of the active bridge (when the active bridge is acting as a rectifier). The output from the first GCBR 506 can be a DC voltage. The first GCBR 506 can be configured to provide various DC voltages at its output. As a particular example, a DC voltage present on a DC voltage bus of the first GCBR 506 can be 600 V. A pre-charge network 508 having a contactor and resistor can be used to limit inrush currents on the DC voltage bus when the DC voltage 522 is applied to a second GCBR 512.

The second GCBR 512 can be configured to invert the input DC voltage 522 to a three-phase AC electrical output 524. In some embodiments, the second GCBR 512 can be the same machine controller as the first GCBR 506, having similar components including an active three-phase bridge, DC link capacitor, sensors for measuring the input DC voltage 522 and three-phase AC electrical output 524, and control electronics for controlling the switching elements of the active bridge. The three-phase AC electrical output 524 can include three components for each phase for voltage and current. In some embodiments, the three-phase AC electrical output is provided in a delta configuration. As a particular example, for a 600 V DC input, the second GCBR 512 can be configured to produce a 360 V AC output. In most cases, the three-phase AC electrical output 524 can include high-frequency voltage artifacts produced by the switching elements of the second GCBR 512. The second GCBR 512 can measure the voltage of the DC voltage 522 instead of the voltage of the three-phase AC electrical output 524 and use the measured input voltage as a proxy for the output voltage.

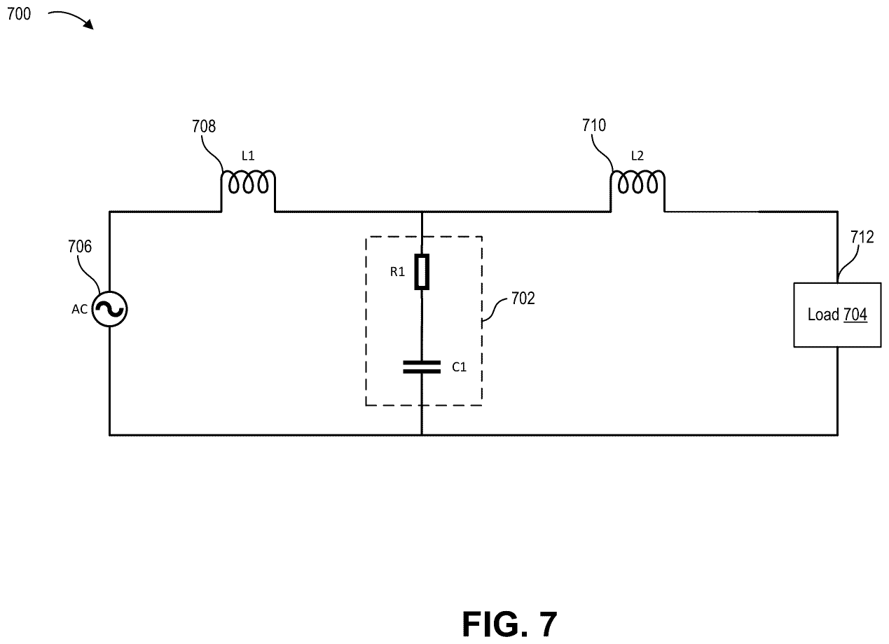

The system 500 can also include a line interface 514. The line interface 514 may be a low-pass filter used to condition the three-phase AC electrical output 524 to attenuate high-frequency components of the three-phase AC electrical output 524. In some examples, the line interface 514 can include one or more inductive three-phase reactors, one or more inductive three-phase common mode chokes, a passive RC network filter, or the like. The values (e.g., inductance, capacitance, resistance) of the line interface 514 components can be used to determine the coefficients m₀, μₚ and μ_{q}, discussed more fully herein. The line interface 514 may produce a filtered AC output 526. Additional details of an exemplary line interface are provided below with respect to FIG. 7.

The system 500 can also include an isolation transformer 516 between the line interface 514 and the load 518. The isolation transformer 516 can be a transformer that provides electrical isolation between the line interface 514 and the load 518. The isolation transformer 516 can have an inductance that provides additional filtering of the filtered AC output 526. The output from the isolation transformer 516 may be the AC load input 528. The isolation transformer 516 may also provide a step-up or step-down of the voltage of the filtered AC output 526, according to the design parameters of the system 500 and the power requirements of the load 518 (e.g., the design of a vehicular power system, the input voltage requirement for load equipment, etc.). As a particular example, for a filtered AC output 526 in a 360 V delta configuration, the AC load input 528 may be a 208 V (line to line), 120 V (line to neutral) three-phase wye configuration after a step-down from the isolation transformer 516.

The load 518 may be various equipment that uses AC power. In some examples, the load 518 can be motors, radar transmitters, and other field equipment that may be connected to a vehicular power system like system 500 and have high power demands during operation. The characteristics (e.g., impedance) of the load 518 may also change during operation, for example due to switching components on and/or off or as the load 518 draws more or less power. The modulation index control techniques described herein can maintain the voltage of the AC load input 528 at a substantially constant voltage despite changes to the characteristics of the load 518. The system 500 may be configured to provide a steady AC load input 528 for a range of apparent power delivered to the load 518. For example, the range of apparent power delivered to the load 518 may vary from 0 kVA to 150 kVA.

Thus, the system 500 illustrated in FIG. 5 receives power from generator 504, creates a DC voltage (e.g., 600 V DC) on a DC voltage bus, illustrated as DC voltage 522, and inverts the DC voltage to produce a three-phase AC voltage (e.g., 208 V AC three-phase voltage), illustrated as AC load input 528, that can be provided to a load 518.

FIG. 6 is a plot 600 illustrating the linearity of values of the modulation index versus apparent power for various power factors of a load, according to some embodiments. The plot 600 was generated via an electrical circuit simulation of components of an exemplary vehicular power system (e.g., system 500 of FIG. 5), including a line interface filter (e.g., line interface 514 of FIG. 5) having inductance values of 150 μH and RC filter network values of 0.167Ω and 150 μF. The simulation also included parasitic resistances and capacitances to better approximate real filter components.

Each line of the plot 600 represents values of the modulation index needed to maintain the 208 V input to the load for a particular value of the load (e.g., load 518 of FIG. 5) connected to a power inverter. Each load is represented by the phase angle φ of the load current characterized by its impedance. For example, line 604 corresponds to a load phase angle φ=36.87°, a lagging phase angle indicative of a load including inductive reactance, while line 606 corresponds to a load phase angle φ=−36.87°, a leading phase angle indicative of a load including capacitive reactance. Line 608 corresponds to a load phase angle φ=0, a purely resistive load.

As demonstrated by the plot 600, each of the lines for various types of loads is substantially linear over a wide range of apparent power delivered to the load. Because of the linearity, the form of the expression for the modulation index m can be given as m=γ[m₀+μₚP_{avg}+μ_{q}Q_{avg}]. The intercept 602 corresponds to the load-independent modulation index m₀, which is the modulation index for the condition in which no apparent power is supplied to the load (e.g., no load connected). The load-independent modulation index m₀ can also be referred to as a no-load modulation index.

By performing a curve fitting operation, for example, a least-squares regression, on the data that produced plot 600, values for m₀, μₚ, and μ_{q} can be determined. For the exemplary filter component values listed above, these values are m₀=0.8464430, μₚ=1.268×10⁻⁴ and μ_{g}=7.288×10⁻⁴. Similar computations can be performed for different filter component values corresponding to the components of different embodiments of the vehicular power system and power inverter that perform the modulation index control techniques described herein. Moreover, the value of m₀ may be determined analytically based on a circuit analysis of the filter network used in conjunction with the power inverter, as discussed below. The computed modulation index m can then be used to control the output of the inverter (e.g., GCBR #2 512 illustrated in FIG. 5).

FIG. 7 is a circuit diagram of an example line interface filter 700 of a power inverter, according to some embodiments. The line interface filter 700 may be an example of line interface 514 discussed above with respect to FIG. 5. The line interface filter 700 may be connected to an AC source 706 and a load 704. The AC source 706 may be an example of three-phase AC electrical output 524 from a GCBR. The voltage of the AC source 706 may be represented as V_{AC}. Load 704 may be an example of load 518 of FIG. 5. For simplicity, the circuit diagram depicted in FIG. 7 represents a single phase of a three-phase system, with the other phases connected to similar filter components.

The line interface filter 700 can include reactor 708 and reactor 710, each of which being a single phase of a three-phase reactor. As discussed above, a particular example can have the inductance values L₁ and L₂ of reactor 708 and reactor 710 as 150 μH. The line interface filter 700 can also include RC network 702. RC network 702 can include a resistive element and a capacitive element. For the particular example discussed above, the RC network 702 can have values for R₁ and C₁ as 0.167Ω and 150 μF, respectively. One skilled in the art would recognize many variations in predetermined component values to provide suitable low-pass filtering for an AC source 706 that includes high-frequency switching artifacts. The output 712 of the filter may be a voltage signal Vₒᵤₜ applied to the load 704. The impedance of the load 704 may be the unknown value Z.

Circuit analysis of the circuit of line interface filter 700 yields an expression for Vₒᵤₜ in terms of the impedance Z of the load 704 and the component values:

$${V}_{out} = {V}_{AC} \frac{( {R}_{1} + \frac{1}{{sC}_{1}} )}{{D}_{Z}} Z , \qquad ( 2 )$$

where

$${D}_{Z} = ( s {L}_{1} + {R}_{1} + \frac{1}{{sC}_{1}} ) ( s {L}_{2} + {R}_{1} + \frac{1}{{sC}_{1}} + Z ) - {[ {R}_{1} + \frac{1}{{sC}_{1}} ]}^{2}$$

is the determinant of the impedance matrix and s=jω. Because

$${V}_{AC} = m \frac{{V}_{DC}}{\sqrt{3}} ,$$

the result is an expression for the modulation index in terms of the known filter component quantities, the measured DC input voltage, and the unknown load impedance Z:

$$m = \frac{{V}_{out} \cdot \sqrt{3} \cdot {D}_{Z}}{{V}_{DC} \cdot ( {R}_{1} + \frac{1}{{sC}_{1}} ) \cdot Z} . \qquad ( 3 )$$

In the limit where Z approaches infinity (corresponding to no load), the expression (3) for the modulation index reduces to

$${m}_{0} = \frac{{V}_{out} \cdot \sqrt{3} \cdot ( {s}^{2} {L}_{1} {C}_{1} + s {C}_{1} {R}_{1} + 1 )}{{V}_{DC} \cdot ( {sC}_{1} {R}_{1} + 1 )} , \qquad ( 4 )$$

which is the analytical expression for the load-independent modulation index in terms of the component values of the line interface filter 700.

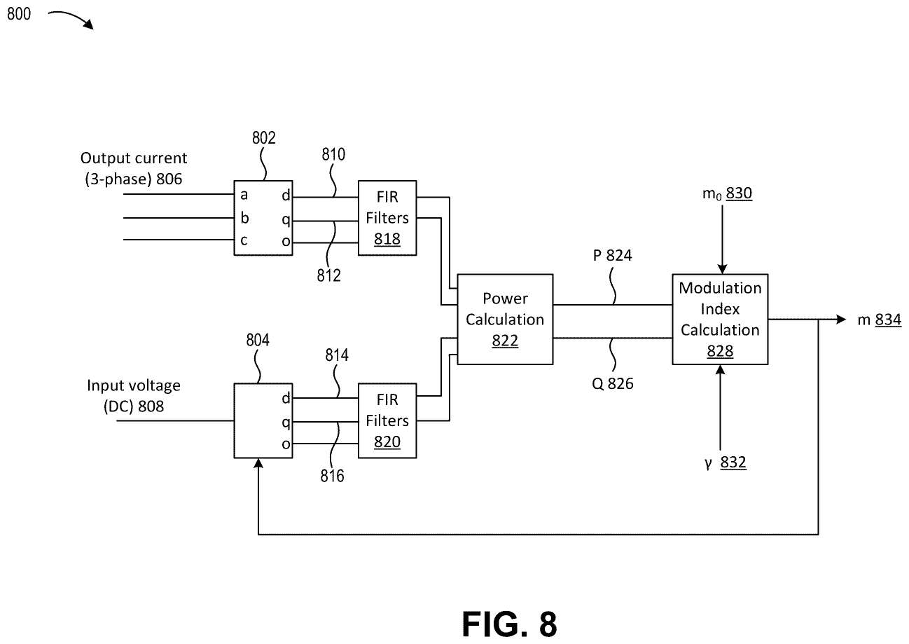

FIG. 8 is a block diagram of a control circuit 800 for computing a modulation index using measured output current and measured input voltage, according to some embodiments. The blocks of the control circuit 800 represent logic components for performing computations, signal processing, and/or logical operations with measured signals in a system implementing recursive modulation index control of an AC output from a power inverter. Measured signals (e.g., an output current 806 at the output of a GCBR) may be sampled at a predetermined sampling rate (e.g., 19.2 kHz).

The output current 806 can be measured at the output of a GCBR acting as a power inverter. The output current 806 can be a three-phase current with a, b, and c components (e.g., Iₐ, I_{b}, and I_{c}). Each current component of the measured output current 806 can be input into a direct-quadrature-zero transformation block 802. The direct-quadrature-zero transformation block 802 (e.g., a Clarke-Park transformer) performs the operations to transform the a, b, and c components to D, Q, and zero components. The output of direct-quadrature-zero transformation block 802 can include a direct current component 810 and a quadrature current component 812. The zero current component signal should have a value of zero; in some embodiments, the output from the direct-quadrature-zero transformation block 802 for the zero current component can be used as an error detection signal.

The input voltage 808 can be measured at the input of a GCBR acting as a power inverter. The input voltage 808 can be a DC signal (e.g., V_{DC}). The input voltage 808 can be input into a transformation block 804. The transformation block 804 can be configured to set a quadrature voltage component 816 as

$${V}_{Q} = \frac{{V}_{AC}}{\sqrt{3}} = m \frac{{V}_{DC}}{\sqrt{3}}$$

and a direct voltage component 814 as V_{Q}=0. As indicated in this expression and depicted in FIG. 8, the determination of the direct voltage component 814 depends on the value of the modulation index. The value of the load-independent modulation index m₀ can be used for the first computation of the direct voltage component in the transformation block 804. Subsequent computations of the direct voltage component 814 can use the computed value of the modulation index 834 calculated for each pass through the control circuit 800. In some embodiments, a measurement of the AC voltage at the load (e.g., load 518 of FIG. 5) connected to the vehicular power system may be obtained. The measured load voltage may be input to the transformation block 804 instead of the measured input voltage 808 to determine the direct voltage component, quadrature voltage component, and zero voltage component using a direct-quadrature-zero transformation similarly to the direct-quadrature-zero transformation block 802.

The direct current component 810 and the quadrature current component 812 can be input into finite impulse response (FIR) filters 818. The FIR filters 818 can be configured to determine a weighted sum of a finite number of samples of the direct current component 810 and quadrature current component 812 input into the FIR filters 818. For example, the FIR filters 818 may compute a weighted sum of N samples; as each new sample is taken, the oldest sample used by the FIR filters 818 can be discarded to update the filtered output from the FIR filters 818. In some embodiments, although this is not required by the present invention, the weights used for the weighted sum can be set to weight the most recent sample more heavily in the weighted sum. In other embodiments, the weights are identical and effectively set to 1/N, with N chosen so that one complete cycle of the ripple frequency can be represented in the FIR window.

The direct voltage component 814 and the quadrature voltage component 816 can similarly be input into FIR filters 820. The FIR filters 820 can be configured similarly to FIR filters 818 to determine a weighted sum of the finite number of samples of the direct voltage component 814 and the quadrature voltage component.

The filtered outputs from FIR filters 818 and FIR filters 820 can be input into power calculation block 822. The power calculation block 822 can be configured to compute a real power 824 and a reactive power 826. As discussed above with respect to FIG. 4, the real power 824 can be determined using as

$${P}_{avg} = \frac{3}{2} ( {V}_{D} {I}_{D} + {V}_{Q} {I}_{Q} ) ,$$

while the reactive power 826 can be determined using cross terms as

$${Q}_{avg} = \frac{3}{2} ( {V}_{D} {I}_{Q} + {V}_{Q} {I}_{D} ) .$$

It will be noted that P_{avg} and Q_{avg} are approximate values since they are based on measurements made at the GCBR. Utilizing the linear profile of the modulation index, these approximate values are useful in adjusting the value of the modulation index and, thereby, controlling the output of the GCBR.

The real power 824 and reactive power 826 can be input into modulation index calculation block 828. The modulation index calculation block 828 can be configured to determine an updated value of the modulation index 834 using m=γ[m₀+μₚP_{avg}+μ_{q}Q_{avg}]. The coefficients μₚ and μ_{g} can be computed as discussed above with respect to FIG. 6, using a regression analysis on simulation results for power inverter and line filter circuit components in the vehicular power system. The control circuit 800 may be configured to select the load-independent modulation index m₀ 830, which may depend on the component values of the line filter used to condition the output current 806 in the vehicular power system. The modulation index calculation block 828 can also be configured to determine a gain factor 832. The gain factor 832 can be determined using

$$γ = \frac{{V}_{nom}}{{V}_{DC}} ,$$

where Vₙₒₘ is the nominal input voltage value.

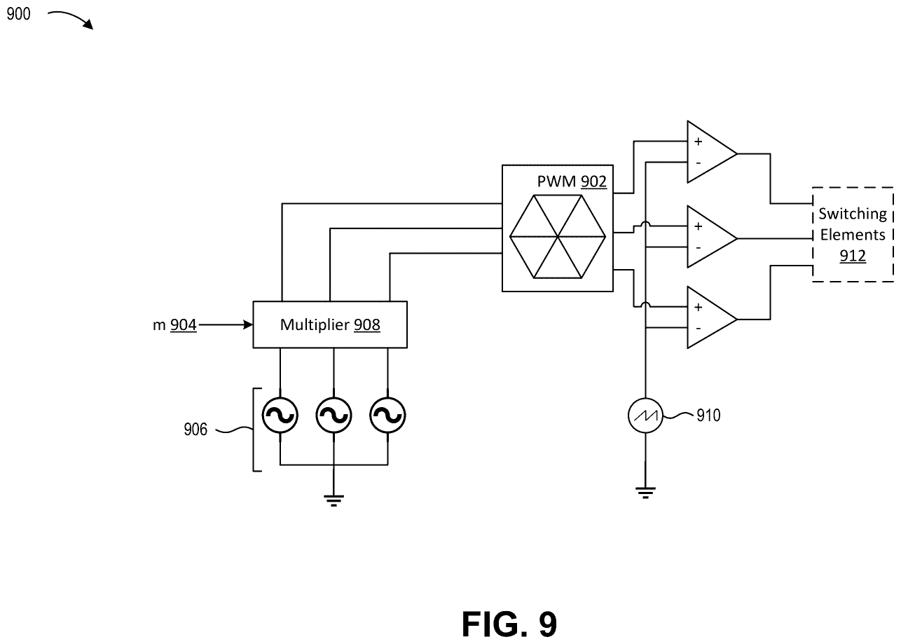

FIG. 9 is a block diagram of a circuit 900 for generating pulse width modulation signals to control switching elements 912 of a power inverter, according to some embodiments. The power inverter can be a GCBR described above with respect to FIG. 5 (e.g., second GCBR 512). The circuit 900 can include a space vector PWM 902 that receives three sinusoidal signals 906 that are each separated by 120° phase.

The amplitudes of each of the sinusoidal signals 906 is multiplied by the modulation index 904 at multiplier 908. The modulation index 904 may be the modulation index 834 computed by the control circuit 800 of FIG. 8. The scaled sinusoidal signals are then input into the space vector PWM 902. The space vector PWM 902 is configured to generate pulse width modulation signals by comparing the scaled sinusoidal signals with a reference sawtooth signal 910 to control the inputs of switching elements 912 of a power inverter. The switching elements 912 may be IGBTs utilized as part of an active bridge. One skilled in the art would recognize many variations in the implementation of a space vector PWM 902 to drive the switching elements 912.

FIG. 10 is a block diagram of a control circuit 1000 that includes a proportional-integral (PI) controller 1002 for determining a weighted average modulation index m_{avg} 1014, according to an embodiment. In cases where an output voltage 1004 is sensed at a load connected to a power inverter and provided to the control circuit of the power inverter, further improvements to the control of the output voltage 1004 can be made in conjunction with the iterative modulation index techniques described herein.

A PI controller 1002 can be configured to determine an error signal as a difference between the measured output voltage 1004 and a nominal voltage 1006. The nominal voltage 1006 may be the voltage value at the load that the machine controller of the power inverter attempts to maintain by iteratively updating the modulation index. The PI controller 1002 can be configured to determine an integral correction using the error signal as well as determine a proportional correction using the error signal. The proportional and integral corrections can be combined to determine an estimated modulation index mₑₛₜ 1008. The control circuit 1000 can include a weighted averaging block 1010 that can be configured to compute a weighted average m_{avg} 1014 of the estimated modulation index mₑₛₜ 1008 and a modulation index 1012 determined using the measured output current of a power inverter as described above with respect to FIGS. 3, 4, and 8. The weighted average m_{avg} 1014 can then be input into the control circuit for iteratively updating the modulation index (e.g., control circuit 800 of FIG. 8). By using both computations of an updated modulation index, the control circuit for the power inverter can take advantage of both the fast response of the iterative update method and the accuracy of a direct measurement of the output voltage at the load (when that measurement is available).

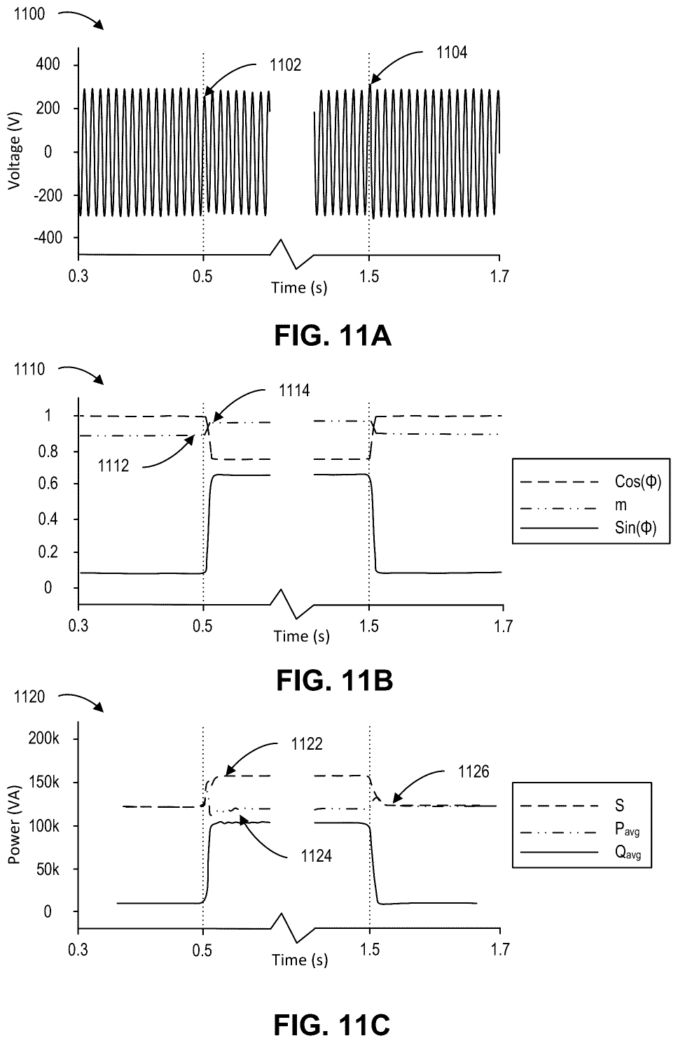

FIGS. 11A-11C are plots illustrating the response of an example power inverter when an inductive load is connected, according to some embodiments. The example power inverter can be configured to output a 360 V AC voltage, which can subsequently be filtered and stepped down to a 208 V three-phase input voltage at the load. The load impedance includes a purely resistive component that uses 120 KW of power and an inductive component that uses 90 kVAR of power connected at 0.5 s and subsequently disconnected at 1.5 s.

FIG. 11A is a plot 1100 of the AC output voltage from the power inverter. When the inductive component of the load is added at 0.5 s, the amplitude of the AC output voltage is briefly reduced 1102, as expected for inductive loading of an AC source. A similar brief increase 1104 of the source voltage is seen in the amplitude when the inductive component of the load is removed at 1.5 s. As shown in the plot 1100, the AC output voltage stabilizes within a few hundred milliseconds of the change in the load characteristics.

FIG. 11B is a plot 1110 illustrating the power factor cos φ, modulation index m, and sine of the phase angle of the power inverter when the inductive component of the load is connected and subsequently disconnected. Because the load is purely resistive prior to 0.5 s, the power factor is unity, as expected, while the modulation index 1112 is approximately 0.85, corresponding to the value of m shown in the plot of FIG. 6 for line 608 at 120 kVA. When the inductive component of the load is added at 0.5 s, the control circuit of the power inverter quickly updates the modulation index. The updated modulation index 1114 reaches a stable value of approximately 0.915 within about 15 ms. The addition of a 90 kVAR inductive component results in an apparent power of 150 kVA and a phase angle of 36.87°, which corresponds to line 604 of FIG. 6 at 150 kVA. A similarly fast response can be seen at 1.5 s when the inductive component of the load is removed.

FIG. 11C is a plot 1120 illustrating the apparent power S, real power P, and reactive power Q from the power inverter when the inductive load is connected and subsequently disconnected. As expected, the addition of an inductive component to the load results in an increase in the apparent power 1122, which stabilizes relatively quickly. Some variation in the real power 1124 can be seen for approximately 30 ms. After the inductive component of the load is removed at 1.5 s, the apparent power 1126 supplied by the power inverter stabilizes at its original value within approximately 15 ms.

The rapid stabilization of the AC output voltage, the apparent power 1122, the real power 1124, as well as the change in the modulation index 1112 can be attributed to the fast response of the recursive computation of an updated modulation index in real time. At the sample rate the power inverter uses to measure the output apparent power, each successive value for the modulation index can be given as:

$${m}_{n} = {γ}_{n - 1} [ {m}_{0} + {μ}_{p} {P}_{avg , n - 1} + {μ}_{q} {Q}_{avg , n - 1} ] . \qquad ( 5 )$$

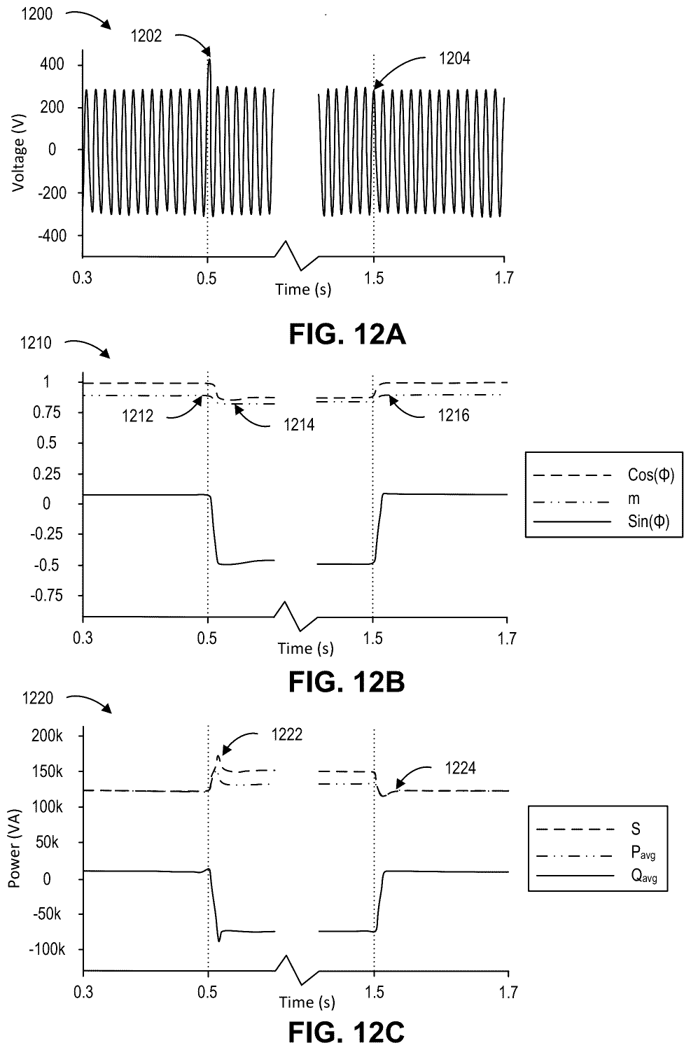

That is, the modulation index is initially set to the no-load value m₀ by the controller of the power inverter. Measurement of the filter input current (to approximate the load current) and the estimate of the driving voltage (to approximate the load voltage) are used to compute real power P_{avg} and reactive power Q_{avg}. Real and reactive power numbers are then used with weighting factors μₚ and μ_{g} to compute an updated modulation index, which may be further adjusted in response to DC bus voltage changes by the feed-forward gain γ. This updated modulation index is used to again adjust the PWM signals driving switching elements, which in turn drive the filter and load, resulting in a change in the load current. This process is then repeated indefinitely, and the modulation index varies in response to DC bus and load changes. A similar response and rapid updating of the modulation index using recursive computations is seen for the addition and removal of a capacitive load as described below with respect to FIGS. 12A-12C.

FIGS. 12A-12C are plots illustrating the response of an example power inverter when a capacitive load is connected, according to some embodiments. The example power inverter can be configured to output a 360 V AC voltage, which can subsequently be filtered and stepped down to a 208 V three-phase input voltage at the load. The load impedance includes a purely resistive component that uses 120 KW of power and a capacitive component that uses 90 kVAR of power connected at 0.5 s and subsequently disconnected at 1.5 s. This configuration is similar to that of FIGS. 11A-11C, but showing the response to an addition of a capacitive impedance at the load.

FIG. 12A is a plot 1200 illustrating an AC output voltage from the power inverter when the capacitive component of the load is connected at 0.5 s and subsequently disconnected at 1.5 s. When the capacitive component of the load is connected at 0.5 s, a brief increase 1202 in the AC output voltage is observed, with a corresponding decrease 1204 in the AC output, as expected for a capacitive load. As with the plot 1100 of FIG. 11, the AC output voltage stabilizes within a few hundred milliseconds of the change in the load characteristics.

FIG. 12B is a plot 1210 illustrating the power factor cos φ, modulation index m, and sine of the phase angle of the power inverter when the capacitive load is connected and subsequently disconnected. Because the load is purely resistive prior to 0.5 s, the power factor is unity, as expected, while the modulation index 1212 is approximately 0.85, corresponding to the value of m shown in the plot of FIG. 6 for line 608 at 120 kVA. When the capacitive component of the load is added at 0.5 s, the control circuit of the power inverter quickly updates the modulation index. The updated modulation index 1214 reaches a stable value of approximately 0.785 within about 15 ms. The addition of a 90 kVAR capacitive component results in an apparent power of 150 kVA and a phase angle of −36.87°, which corresponds to line 606 of FIG. 6 at 150 kVA. A similarly fast response can be seen at 1.5 s when the capacitive component of the load is removed. The modulation factor 1216 returns to a value of approximately 0.85 within about 15 ms.

FIG. 12C is a plot 1220 illustrating the apparent power S, real power P, and reactive power Q from the power inverter when the when the capacitive component of the load is connected and subsequently disconnected. As expected, the addition of a capacitive component to the load results in an increase in the apparent power 1222, which stabilizes relatively quickly. After the capacitive component of the load is removed at 1.5 s, the apparent power 1224 supplied by the power inverter stabilizes at its original value within approximately 15 ms.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks. For example, processors can reside inside the GCBR or machine controller. A processor may control the switching of the TIG winding configuration between import/export and electrical power generation.

Having described several example configurations, various modifications, alternative constructions, and equivalents may be used without departing from the spirit of the disclosure. For example, the above elements may be components of a larger system, wherein other rules may take precedence over or otherwise modify the application of the disclosure. Also, a number of steps may be undertaken before, during, or after the above elements are considered.

What is claimed is:

1. A method for controlling a power inverter, the method comprising:
selecting a modulation index;
measuring an input voltage to the power inverter;
estimating an output voltage of the power inverter based on the input voltage and the modulation index;
measuring an output current of the power inverter;
determining a real power and a reactive power using the output voltage and the output current;
determining an updated modulation index using the real power and the reactive power;
generating pulse width modulation signals using the updated modulation index; and
controlling the power inverter using the pulse width modulation signals.

2. The method of claim 1, wherein updating the modulation index further comprises computing an estimated output voltage of the power inverter using the modulation index and the measured input voltage.

3. The method of claim 2, wherein determining the real power and the reactive power comprises:
applying a direct-quadrature-zero transform to the output current to produce a direct current component and a quadrature current component; and
computing the real power and the reactive power using the direct current component, the quadrature current component, and the estimated output voltage.

4. The method of claim 1, further comprising generating updated pulse width modulation signals using the updated modulation index, the updated pulse width modulation signals causing the power inverter to produce an updated output current.

5. The method of claim 1, wherein updating the modulation index is performed iteratively at a predefined rate.

6. The method of claim 5, wherein measuring the input voltage comprises measuring the input voltage at the predefined rate, and wherein measuring the output current comprises measuring the output current at the predefined rate.

7. The method of claim 5, wherein the predefined rate is about 19.2 kHz.

8. The method of claim 1, wherein determining the updated modulation index further comprises applying a gain factor to the selected modulation index, the determined real power, and the determined reactive power.

9. The method of claim 1, wherein controlling the power inverter comprises using the pulse width modulation signals to control switching elements of the power inverter to produce an output current from the power inverter.

10. A method for controlling a power inverter, the method comprising:
(a) measuring an input voltage to the power inverter;
(b) computing a nominal output voltage based on a modulation index;
(c) measuring an output current of the power inverter;
(d) determining a real power and a reactive power using the nominal output voltage and the output current; and
(e) determining an updated modulation index using the real power and the reactive power; and
iteratively performing steps (a) through (e).

11. The method of claim 10, wherein determining the real power and the reactive power comprises:
applying a direct-quadrature-zero transform to the output current to produce a direct current component and a quadrature current component;
computing the real power according to
$${P}_{avg} = \frac{3}{2} ( {V}_{D} {I}_{D} + {V}_{Q} {I}_{Q} ) ,$$
wherein P_{avg} is the real power, V_{D} is a direct voltage component, V_{Q} is a quadrature voltage component, I_{D} is the direct current component, and I_{Q} is the quadrature current component; and
computing the reactive power according to
$${Q}_{avg} = \frac{3}{2} ( {V}_{D} {I}_{Q} + {V}_{Q} {I}_{D} ) ,$$
wherein Q_{avg} is the reactive power.

12. The method of claim 11, wherein the direct voltage component V_{D}=0, the quadrature voltage component
$${V}_{Q} = \frac{{V}_{AC}}{\sqrt{3}} ,$$
and V_{AC} is the nominal output voltage.

13. The method of claim 10, further comprising measuring a load voltage at a load electrically connected to the power inverter.

14. The method of claim 13, wherein determining the updated modulation index comprises:
applying, using a proportional-integral controller, an integral correction to the load voltage to produce a corrected load voltage;
computing a first index factor using the real power and the reactive power;
computing a second index factor using the corrected load voltage; and
computing a weighted sum of the first index factor and the second index factor to produce the updated modulation index.

15. The method of claim 10, wherein generating the output current comprises generating pulse width modulation signals using the updated modulation index, the pulse width modulation signals usable to control switching elements of the power inverter to produce the output current from the power inverter.

16. The method of claim 10, wherein iteratively performing steps (a) through (e) occurs at a predefined rate.

17. A power inverter system, comprising:
a line interface filter comprising filter components having predetermined component values; and
a generator controller bus regulator electrically connected to the line interface filter and configured to receive DC power and generate AC power by iteratively updating a modulation index, wherein the modulation index is characterized by the predetermined component values.

18. The power inverter system of claim 17, wherein the generator controller bus regulator is configured to iteratively update the modulation index by:
measuring an input voltage of the DC power;
measuring an output current from the generator controller bus regulator to the line interface filter;
determining a real power and a reactive power using the input voltage and the output current; and
determining the modulation index using the determined real power, the determined reactive power, and a load-independent modulation index.

19. The power inverter system of claim 17, further comprising an isolation transformer electrically connected to the line interface filter.

20. The power inverter system of claim 19, wherein the isolation transformer is characterized by a turns ratio and a winding number, and wherein the line interface filter and the isolation transformer are configured to receive the AC power generated by the generator controller bus regulator and transmit a corresponding AC output to a load connected to the isolation transformer.
